(19) United States
(12) Patent Application Publication
(10) Pub. No.: US 2026/0222584 A1
(43) Pub. Date: Jul. 30, 2026

(54) METHOD AND APPARATUS FOR ENCODING/DECODING IMAGE AND RECORDING MEDIUM FOR STORING BITSTREAM

(71) Applicants: HYUNDAI MOTOR COMPANY, Seoul (KR); KIA CORPORATION, Seoul (KR)

(72) Inventors: Jin Heo, Yongin-si (KR); Jungah Choi, Seoul (KR); Seung Wook Park, Yongin-si (KR)

(73) Assignees: HYUNDAI MOTOR COMPANY, Seoul (KR); KIA CORPORATION, Seoul (KR)

(21) Appl. No.: 19/145,346

(22) PCT Filed: Mar. 15, 2024
(86) PCT No.: PCT/KR2024/003294

§ 371 Date: Jul. 2, 2025

(30) Foreign Application Priority Data
Mar. 15, 2023 (KR) 10-2023-0034135
Mar. 15, 2024 (KR) 10-2024-0036301

(51) Int. Cl. H04N 19/137; H04N 19/159; H04N 19/176

(52) U.S. Cl. CPC H04N 19/137; H04N 19/159; H04N 19/176

(57) ABSTRACT

A method and apparatus for encoding/decoding an image, a recording medium for storing a bitstream, and a transmission method are provided. The method for decoding the image includes generating an inter prediction block of a current block, generating an intra prediction block of the current block, and generating a final prediction block of the current block by performing weighted summation of the inter prediction block and the intra prediction block, and the intra prediction block may be generated based on one of intra template matching prediction and intra block copy.

### TECHNICAL FIELD

The prevent invention relates to a method and apparatus for encoding/decoding an image and a recording medium for storing a bitstream. Particularly, the present invention relates to a method and apparatus for encoding/decoding an image, which are based on an improved combined intra inter prediction method, and a recording medium for storing a bitstream.

### BACKGROUND ART

Recently, the demand for high resolution and high quality images such as ultra high definition (UHD) images increases in various application image data becomes higher in resolution and quality, the amount of data increases relatively compared to existing image data. Therefore, when transmitting such image data using existing media such as wired or wireless broadband channels, or when storing it using existing storage media, both transmission and storage costs increase. To solve these problems that occur as image data becomes higher in resolution and quality, a high-efficiency image encoding/decoding technique is required for images with higher resolution and image quality.

Combined intra inter prediction generates a prediction block by performing weighted summation of an intra prediction signal and an inter prediction signal. Particularly, the conventional combined intra inter prediction generates an intra prediction signal by using a template-based intra mode derivation (TIMD) method, and the template-based intra mode derivation method generates an intra prediction signal from a restricted intra prediction mode, thereby causing a problem with accuracy of the intra prediction signal.

### DISCLOSURE

### Technical Problem

An object of the present invention is to provide a method and apparatus for encoding/decoding an image with improved encoding/decoding efficiency.

Another object of the present invention is to provide a recording medium for storing a bitstream that is generated by generated by a method or apparatus for decoding an image according to the present invention.

Another object of the present invention is to provide improved combined intra inter prediction for solving the above-described problem of the conventional combined intra inter prediction.

### Technical Solution

A method for decoding an image according to an embodiment of the present invention includes generating an inter prediction block of a current block, generating an intra prediction block of the current block, and generating a final prediction block of the current block by performing weighted summation of the inter prediction block and the intra prediction block, and the intra prediction block may be generated based on one of intra template matching prediction and intra block copy.

In the method for decoding an image, the inter prediction block may be generated by performing inter prediction of a merge mode.

In the method for decoding an image, when the intra prediction block is generated based on intra block copy, a block vector used for the intra block copy may be determined based on a motion vector that is used to generate the inter prediction block.

In the method for decoding an image, the block vector may be derived by adding a vector difference value to the motion vector.

In the method for decoding an image, the vector difference value may be obtained from a bitstream.

In the method for decoding an image, a resolution of the block vector may be adjusted based on a resolution of the motion vector.

In the method for decoding an image, the resolution of the motion vector may be adjusted based on the resolution of the block vector.

In the method for decoding an image, the block vector may be derived based on a distance between a current picture including the current block and a reference picture that is used to generate the inter prediction block.

In the method for decoding an image, the weighted summation may be performed by applying an inter prediction weight and an intra prediction weight to the inter prediction block and the intra prediction block, respectively.

In the method for decoding an image, the inter prediction weight and the intra prediction weight may be determined based on a distortion value of the inter prediction block and a distortion value of the intra prediction block.

In the method for decoding an image, the inter prediction weight and the intra prediction weight may be determined based on a prediction mode of at least two neighboring blocks of the current block.

A method for encoding an image according to an embodiment of the present invention includes generating an inter prediction block of a current block, generating an intra prediction block of the current block, and generating a final prediction block of the current block by performing weighted summation of the inter prediction block and the intra prediction block, and the intra prediction block may be generated based on one of intra template matching prediction and intra block copy.

A non-transitory computer-readable recording medium according to an embodiment of the present invention may store a bitstream generated by a method for encoding an image. The method for encoding the image includes generating an inter prediction block of a current block, generating an intra prediction block of the current block, and generating a final prediction block of the current block by performing weighted summation of the inter prediction block and the intra prediction block, and the intra prediction block is generated based on one of intra template matching prediction and intra block copy.

A method for transmitting a bitstream generated by a method for encoding an image according to an embodiment of the present invention includes transmitting the bitstream. The method for encoding the image includes generating an inter prediction block of a current block, generating an intra prediction block of the current block, and generating a final prediction block of the current block by performing weighted summation of the inter prediction block and the intra prediction block, and the intra prediction block is generated based on one of intra template matching prediction and intra block copy.

The features briefly summarized above with respect to the present disclosure are provided as an example only to explain the detailed description and are not construed to limit the scope of the present disclosure.

### Advantageous Effects

According to the present invention, it is possible to provide a method and apparatus for encoding/decoding an image with improved encoding/decoding efficiency.

In addition, according to the present invention, it is possible to provide improved combined intra inter prediction.

In addition, according to the present invention, it is possible to improve accuracy of intra prediction.

Effects obtainable from the present disclosure are not limited to the above-mentioned effects, and other effects that are not mentioned will be clearly understood by those skilled in the art from the following description.

### DESCRIPTION OF DRAWINGS

FIG. 1 is a block diagram showing a configuration of an encoding apparatus according to an embodiment of the present invention.

FIG. 2 is a block diagram showing a configuration of a decoding apparatus according to an embodiment of the present invention.

FIG. 3 is a diagram schematically showing a video coding system to which the present invention is applicable.

FIG. 4 is a view for describing an intra template matching-based combined inter intra prediction method according to an embodiment of the present invention.

FIG. 5 is a view for describing a combined inter intra prediction method based on intra block copy according to an embodiment of the present invention.

FIG. 6 is a view showing a method for reducing an amount of information on a block vector by using a motion vector according to an embodiment of the present invention.

FIG. 7 is a flowchart showing a method for decoding an image according to an embodiment of the present invention.

FIG. 8 is a view for illustrating a content streaming system to which an embodiment according to the present invention is applicable.

### MODE FOR INVENTION

The present invention may have various modifications and embodiments, and specific embodiments are illustrated in the drawings and described in detail in the detailed description. However, this is not intended to limit the present invention to specific embodiments, but should be understood to include all modifications, equivalents, or substitutes included in the spirit and technical scope of the present invention. Similar reference numerals in the drawings indicate the same or similar functions throughout various aspects. The shapes and sizes of elements in the drawings may be provided by way of example for a clearer description. The detailed description of the exemplary embodiments described below refers to the accompanying drawings, which illustrate specific embodiments by way of example. These embodiments are described in sufficient detail to enable those skilled in the art to practice the embodiments. It should be understood that the various embodiments are different from each other, but are not necessarily mutually exclusive. For example, specific shapes, structures, and characteristics described herein may be implemented in other embodiments without departing from the spirit and scope of the present invention with respect to one embodiment. It should also be understood that the positions or arrangements of individual components within each disclosed embodiment may be changed without departing from the spirit and scope of the embodiment. Accordingly, the detailed description set forth below is not intended to be limiting, and the scope of the exemplary embodiments is defined only by the appended claims, along with the full scope of equivalents to which such claims are entitled, if properly described.

In the present invention, the terms first, second, etc. may be used to describe various components, but the components should not be limited by the terms. The terms are only used for the purpose of distinguishing one component from another. For example, without departing from the scope of the present invention, the first component may be referred to as the second component, and similarly, the second component may also be referred to as the first component. The term is and/or includes a combination of a plurality of related described items or any item among a plurality of related described items.

The components shown in the embodiments of the present invention are independently depicted to indicate different characteristic functions, and do not mean that each component is formed as a separate hardware or software configuration unit. That is, each component is listed and included as a separate component for convenience of explanation, and at least two of the components may be combined to form a single component, or one component may be divided into multiple components to perform a function, and embodiments in which components are integrated and embodiments in which each component is divided are also included in the scope of the present invention as long as they do not deviate from the essence of the present invention.

The terminology used in the present invention is only used to describe specific embodiments and is not intended to limit the present invention. The singular expression includes the plural expression unless the context clearly indicates otherwise. In addition, some components of the present invention are not essential components that perform essential functions in the present invention and may be optional components only for improving performance. The present invention may be implemented by including only essential components for implementing the essence of the present invention excluding components only used for improving performance, and a structure including only essential components excluding optional components only used for improving performance is also included in the scope of the present invention.

In an embodiment, the term “at least one” may mean one of a number greater than or equal to 1, such as 1, 2, 3, and 4. In an embodiment, the term “a plurality of” may mean one of a number greater than or equal to 2, such as 2, 3, and 4.

Hereinafter, embodiments of the present invention will be specifically described with reference to the drawings. In describing the embodiments of this specification, if it is determined that a detailed description of a related known configuration or function may obscure the subject matter of this specification, the detailed description will be omitted, and the same reference numerals will be used for the same components in the drawings, and repeated descriptions of the same components will be omitted.

### Description of Terms

Hereinafter, “image” may mean one picture constituting a video, and may also refer to the video itself. For example, “encoding and/or decoding of an image” may mean “encoding and/or decoding of a video,” and may also mean “encoding and/or decoding of one of images constituting the video.”

Hereinafter, “moving image” and “video” may be used with the same meaning and may be used interchangeably. In addition, a target image may be an encoding target image that is a target of encoding and/or a decoding target image that is a target of decoding. In addition, the target image may be an input image input to an encoding apparatus and may be an input image input to a decoding apparatus. Here, the target image may have the same meaning as a current image.

Hereinafter, encoder and image encoding apparatus may be used with the same meaning and may be used interchangeably.

Hereinafter, decoder and image decoding apparatus may be used with the same meaning and may be used interchangeably.

Hereinafter, “image”, “picture”, “frame” and “screen” may be used with the same meaning and may be used interchangeably.

Hereinafter, a “target block” may be an encoding target block that is a target of encoding and/or a decoding target block that is a target of decoding. In addition, the target block may be a current block that is a target of current encoding and/or decoding. For example, “target block” and “current block” may be used with the same meaning and may be used interchangeably.

Hereinafter, “block” and “unit” may be used with the same meaning and may be used interchangeably. In addition, “unit” may mean including a luma component block and a chroma component block corresponding thereto in order to distinguish it from a block. For example, a coding tree unit (CTU) may be composed of one luma component (Y) coding tree block (CTB) and two chroma component (Cb, Cr) coding tree blocks related to it.

Hereinafter, “sample”, “picture element” and “pixel” may be used with the same meaning and may be used interchangeably. Herein, a sample may represent a basic unit that constitutes a block.

Hereinafter, “inter” and “inter-screen” may be used with the same meaning and can be used interchangeably.

Hereinafter, “intra” and “in-screen” may be used with the same meaning and can be used interchangeably.

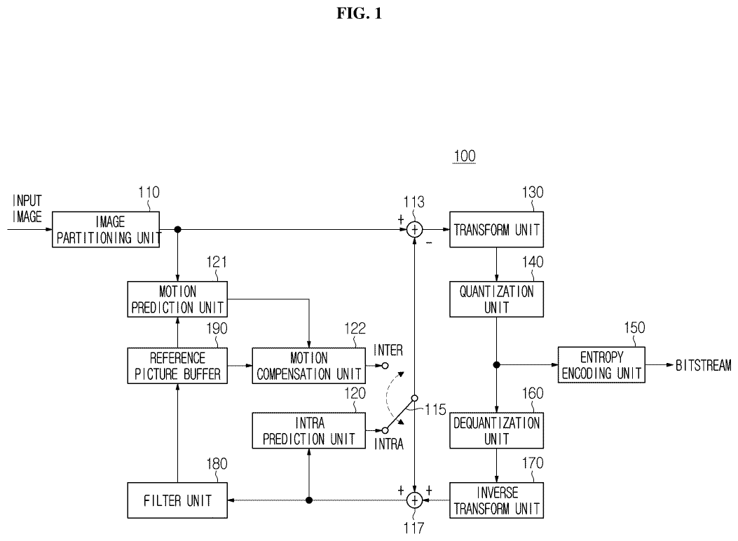

FIG. 1 is a block diagram showing a configuration of an encoding apparatus according to an embodiment of the present invention.

The encoding apparatus 100 may be an encoder, a video encoding apparatus, or an image encoding apparatus. A video may include one or more images. The encoding apparatus 100 may sequentially encode one or more images.

Referring to FIG. 1, the encoding apparatus 100 may include an image partitioning unit 110, an intra prediction unit 120, a motion prediction unit 121, a motion compensation unit 122, a switch 115, a subtractor 113, a transform unit 130, a quantization unit 140, an entropy encoding unit 150, a dequantization unit 160, an inverse transform unit 170, an adder 117, a filter unit 180 and a reference picture buffer 190.

In addition, the encoding apparatus 100 may generate a bitstream including information encoded through encoding of an input image, and output the generated bitstream. The generated bitstream may be stored in a computer-readable recording medium, or may be streamed through a wired/wireless transmission medium.

The image partitioning unit 110 may partition the input image into various forms to increase the efficiency of video encoding/decoding. That is, the input video is composed of multiple pictures, and one picture may be hierarchically partitioned and processed for compression efficiency, parallel processing, etc. For example, one picture may be partitioned into one or multiple tiles or slices, and then partitioned again into multiple CTUS (Coding Tree Units). Alternatively, one picture may first be partitioned into multiple sub-pictures defined as groups of rectangular slices, and each sub-picture may be partitioned into the tiles/slices. Here, the sub-picture may be utilized to support the function of partially independently encoding/decoding and transmitting the picture. Since multiple sub-pictures may be individually reconstructed, it has the advantage of easy editing in applications that configure multi-channel inputs into one picture. In addition, a tile may be divided horizontally to generate bricks. Here, the brick may be utilized as the basic unit of parallel processing within the picture. In addition, one CTU may be recursively partitioned into quad trees (QTs), and the terminal node of the partition may be defined as a CU (Coding Unit). The CU may be partitioned into a PU (Prediction Unit), which is a prediction unit, and a TU (Transform Unit), which is a transform unit, to perform prediction and partition. Meanwhile, the CU may be utilized as the prediction unit and/or the transform unit itself. Here, for flexible partition, each CTU may be recursively partitioned into multi-type trees (MTTs) as well as quad trees (QTs). The partition of the CTU into multi-type trees may start from the terminal node of the QT, and the MTT may be composed of a binary tree (BT) and a triple tree (TT). For example, the MTT structure may be classified into a vertical binary split mode (SPLIT_BT_VER), a horizontal binary split mode (SPLIT_BT_HOR), a vertical ternary split mode (SPLIT_TT_VER), and a horizontal ternary split mode (SPLIT_TT_HOR). In addition, a minimum block size (MinQTSize) of the quad tree of the luma block during partition may be set to 16×16, a maximum block size (MaxBtSize) of the binary tree may be set to 128×128, and a maximum block size (MaxTtSize) of the triple tree may be set to 64×64. In addition, a minimum block size (MinBtSize) of the binary tree and a minimum block size (MinTtSize) of the triple tree may be specified as 4×4, and the maximum depth (MaxMttDepth) of the multi-type tree may be specified as 4. In addition, in order to increase the encoding efficiency of the I slice, a dual tree that differently uses CTU partition structures of luma and chroma components may be applied. On the other hand, in P and B slices, the luma and chroma CTBs (Coding Tree Blocks) within the CTU may be partitioned into a single tree that shares the coding tree structure.

The encoding apparatus 100 may perform encoding on the input image in the intra mode and/or the inter mode. Alternatively, the encoding apparatus 100 may perform encoding on the input image in a third mode (e.g., IBC mode, Palette mode, etc.) other than the intra mode and the inter mode. However, if the third mode has functional characteristics similar to the intra mode or the inter mode, it may be classified as the intra mode or the inter mode for convenience of explanation. In the present invention, the third mode will be classified and described separately only when a specific description thereof is required.

When the intra mode is used as the prediction mode, the switch 115 may be switched to intra, and when the inter mode is used as the prediction mode, the switch 115 may be switched to inter. Here, the intra mode may mean an intra prediction mode, and the inter mode may mean an inter prediction mode. The encoding apparatus 100 may generate a prediction block for an input block of the input image. In addition, the encoding apparatus encode a residual block using a residual of the input block and the prediction block after the prediction block is generated. The input image may be referred to as a current image which is a current encoding target. The input block may be referred to as a current block which is a current encoding target or an encoding target block.

When a prediction mode is an intra mode, the intra prediction unit 120 may use a sample of a block that has been already encoded/decoded around a current block as a reference sample. The intra prediction unit 120 may perform spatial prediction for the current block by using the reference sample, or generate prediction samples of an input block through spatial prediction. Herein, the intra prediction may mean in-screen prediction.

As an intra prediction method, non-directional prediction modes such as DC mode and Planar mode and directional prediction modes (e.g., 65 directions) may be applied. Here, the intra prediction method may be expressed as an intra prediction mode or an in-screen prediction mode.

When a prediction mode is an inter mode, the motion prediction unit 121 may retrieve a region that best matches with an input block from a reference image in a motion prediction process, and derive a motion vector by using the retrieved region. In this case, a search region may be used as the region. The reference image may be stored in the reference picture buffer 190. Here, when encoding/decoding for the reference image is performed, it may be stored in the reference picture buffer 190.

The motion compensation unit 122 may generate a prediction block of the current block by performing motion compensation using a motion vector. Herein, inter prediction may mean inter-screen prediction or motion compensation.

When the value of the motion vector is not an integer, the motion prediction unit 121 and the motion compensation unit 122 may generate the prediction block by applying an interpolation filter to a partial region of the reference picture. In order to perform inter prediction or motion compensation, it may be determined whether the motion prediction and motion compensation mode of the prediction unit included in the coding unit is one of a skip mode, a merge mode, an advanced motion vector prediction (AMVP) mode, and an intra block copy (IBC) mode based on the coding unit and inter prediction or motion compensation may be performed according to each mode.

In addition, based on the above inter prediction method, an AFFINE mode of sub-PU based prediction, an SbTMVP (Subblock-based Temporal Motion Vector Prediction) mode, an MMVD (Merge with MVD) mode of PU-based prediction, and a GPM (Geometric Partitioning Mode) mode may be applied. In addition, in order to improve the performance of each mode, HMVP (History based MVP), PAMVP (Pairwise Average MVP), CIIP (Combined Intra/Inter Prediction), AMVR (Adaptive Motion Vector Resolution), BDOF (Bi-Directional Optical-Flow), BCW (Bi-predictive with CU Weights), LIC (Local Illumination Compensation), TM (Template Matching), OBMC (Overlapped Block Motion Compensation), etc. may be applied.

Among these, the AFFINE mode is a technology that is used in both AMVP and MERGE modes and also has high encoding efficiency. In the existing video coding standard, since MC (Motion Compensation) is performed by considering only the parallel movement of blocks, it has a disadvantage in that it cannot properly compensate for motions that occur in reality, such as zoom-in/out and rotation. To supplement this, a four-parameter affine motion model using two control point motion vectors (CPMVs) and a six-parameter affine motion model using three control point motion vectors may be used and applied to inter prediction. Here, CPMV is a vector representing the affine motion model of one of the upper left, upper right, and lower left of the current block.

The subtractor 113 may generate a residual block by using a difference between an input block and a prediction block. The residual block may be called a residual signal. The residual signal may mean a difference between an original signal and a prediction signal. Alternatively, the residual signal may be a signal generated by transforming or quantizing, or transforming and quantizing a difference between the original signal and the prediction signal. The residual block may be a residual signal of a block unit.

The transform unit 130 may generate a transform coefficient by performing transform on a residual block, and output the generated transform coefficient. Herein, the transform coefficient may be a coefficient value generated by performing transform on the residual block. When a transform skip mode is applied, the transform unit 130 may skip transform of the residual block.

A quantized level may be generated by applying quantization to the transform coefficient or to the residual signal. Hereinafter, the quantized level may also be called a transform coefficient in embodiments.

For example, a 4×4 luma residual block generated through intra prediction is transformed using a base vector based on DST (Discrete Sine Transform), and transform may be performed on the remaining residual block using a base vector based on DCT (Discrete Cosine Transform). In addition, a transform block is partitioned into a quad tree shape for one block using ROT (Residual Quad Tree) technology, and after performing transform and quantization on each transformed block partitioned through ROT, a coded block flag (cbf) may be transmitted to increase encoding efficiency when all coefficients become 0.

As another alternative, the Multiple Transform Selection (MTS) technique, which selectively uses multiple transform bases to perform transform, may be applied. That is, instead of partitioning a CU into TUs through ROT, a function similar to TU partition may be performed through the sub-block Transform (SBT) technique. Specifically, SBT is applied only to inter prediction blocks, and unlike ROT, the current block may be partitioned into 12 or 14 sizes in the vertical or horizontal direction and then transform may be performed on only one of the blocks. For example, if it is partitioned vertically, transform may be performed on the leftmost or rightmost block, and if it is partitioned horizontally, transform may be performed on the topmost or bottommost block.

In addition, LENST (Low Frequency Non-Separable Transform), a secondary transform technique that additionally transforms the residual signal transformed into the frequency domain through DCT or DST, may be applied. LFNST additionally performs transform on the low-frequency region of 4×4 or 8×8 in the upper left, so that the residual coefficients may be concentrated in the upper left.

The quantization unit 140 may generate a quantized level by quantizing the transform coefficient or the residual signal according to a quantization parameter (QP), and output the generated quantized level. Herein, the quantization unit 140 may quantize the transform coefficient by using a quantization matrix.

For example, a quantizer using QP values of 0 to 51 may be used. Alternatively, if the image size is larger and high encoding efficiency is required, the QP of 0 to 63 may be used. Also, a DQ (Dependent Quantization) method using two quantizers instead of one quantizer may be applied. DQ performs quantization using two quantizers (e.g., 00 and Q1), but even without signaling information about the use of a specific quantizer, the quantizer to be used for the next transform coefficient may be selected based on the current state through a state transition model.

The entropy encoding unit 150 may generate a bitstream by performing entropy encoding according to a probability distribution on values calculated by the quantization unit 140 or on coding parameter values calculated when performing encoding, and output the bitstream. The entropy encoding unit 150 may perform entropy encoding of information on a sample of an image and information for decoding an image. For example, the information for decoding the image may include a syntax element.

When entropy encoding is applied, symbols are represented so that a smaller number of bits are assigned to a symbol having a high occurrence probability and a larger number of bits are assigned to a symbol having a low occurrence probability, and thus, the size of bit stream for symbols to be encoded may be decreased. The entropy encoding unit 150 may use an encoding method, such as exponential Golomb, context-adaptive variable length coding (CAVLC), context-adaptive binary arithmetic coding (CABAC), etc., for entropy encoding. For example, the entropy encoding unit 150 may perform entropy encoding by using a variable length coding/code (VLC) table. In addition, the entropy encoding unit 150 may derive a binarization method of a target symbol and a probability model of a target symbol/bin, and perform arithmetic coding by using the derived binarization method, and a context model.

In relation to this, when applying CABAC, in order to reduce the size of the probability table stored in the decoding apparatus, a table probability update method may be changed to a table update method using a simple equation and applied. In addition, two different probability models may be used to obtain more accurate symbol probability values.

In order to encode a transform coefficient level (quantized level), the entropy encoding unit 150 may change a two-dimensional block form coefficient into a one-dimensional vector form through a transform coefficient scanning method.

A coding parameter may include information (flag, index, etc.) encoded in the encoding apparatus 100 and signaled to the decoding apparatus 200, such as syntax element, and information derived in the encoding or decoding process, and may mean information required when encoding or decoding an image.

Herein, signaling the flag or index may mean that a corresponding flag or index is entropy encoded and included in a bitstream in an encoder, and may mean that the corresponding flag or index is entropy decoded from a bitstream in a decoder.

The encoded current image may be used as a reference image for another image to be processed later. Therefore, the encoding apparatus 100 may reconstruct or decode the encoded current image again and store the reconstructed or decoded image as a reference image in the reference picture buffer 190.

A quantized level may be dequantized in the dequantization unit 160, or may be inversely transformed in the inverse transform unit 170. A dequantized and/or inversely transformed coefficient may be added with a prediction block through the adder 117. Herein, the dequantized and/or inversely transformed coefficient may mean a coefficient on which at least one of dequantization and inverse transform is performed, and may mean a reconstructed residual block. The dequantization unit 160 and the inverse transform unit 170 may be performed as an inverse process of the quantization unit 140 and the transform unit 130.

The reconstructed block may pass through the filter unit 180. The filter unit 180 may apply a deblocking filter, a sample adaptive offset (SAO), an adaptive loop filter (ALF), a bilateral filter (BIF), luma mapping with chroma scaling (LMCS), etc. to a reconstructed sample, a reconstructed block or a reconstructed image using all or some filtering techniques. The filter unit 180 may be called an in-loop filter. In this case, the in-loop filter is also used as name excluding LMCS.

The deblocking filter may remove block distortion generated in boundaries between blocks. In order to determine whether or not to apply a deblocking filter, whether w or not to apply a deblocking filter to a current block may be determined based on samples included in several rows or columns which are included in the block. When a deblocking filter is applied to a block, a different filter may be applied according to a required deblocking filtering strength.

In order to compensate for encoding error using sample adaptive offset, a proper offset value may be added to a sample value. The sample adaptive offset may correct an offset of a deblocked image from an original image by a sample unit. A method of partitioning a sample included in an image into a predetermined number of regions, determining a region to which an offset is applied, and applying the offset to the determined region, or a method of applying an offset in consideration of edge information on each sample may be used.

A bilateral filter (BIF) may also correct the offset from the original image on a sample-by-sample basis for the image on which deblocking has been performed.

The adaptive loop filter may perform filtering based on a comparison result of the reconstructed image and the original image. Samples included in an image may be partitioned into predetermined groups, a filter to be applied to each group may be determined, and differential filtering may be performed for each group. Information of whether or not to apply the ALF may be signaled by coding units (CUs), and a form and coefficient of the adaptive loop filter to be applied to each block may vary.

In LMCS (Luma Mapping with Chroma Scaling), luma mapping (LM) means remapping luma values through a piece-wise linear model, and chroma scaling (CS) means a technique for scaling the residual value of the chroma component according to the average luma value of the prediction signal. In particular, LMCS may be utilized as an HDR correction technique that reflects the characteristics of HDR (High Dynamic Range) images.

The reconstructed block or the reconstructed image having passed through the filter unit 180 may be stored in the reference picture buffer 190. A reconstructed block that has passed through the filter unit 180 may be a part of a reference image. That is, the reference image is a reconstructed image composed of reconstructed blocks that have passed through the filter unit 180. The stored reference image may be used later in inter prediction or motion compensation.

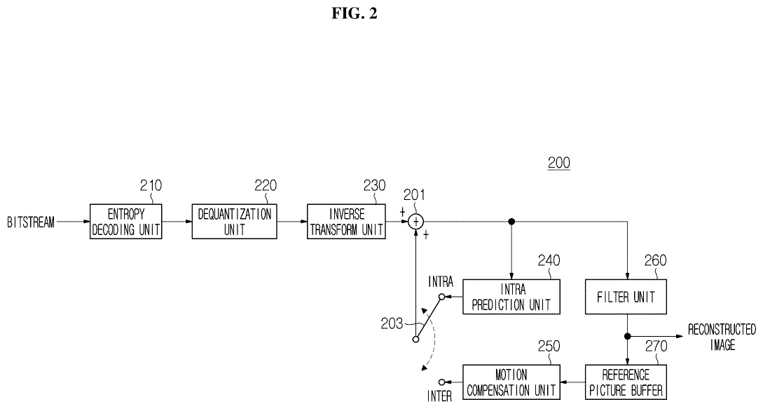

FIG. 2 is a block diagram showing a configuration of a decoding apparatus according to an embodiment of the present invention.

A decoding apparatus 200 may a decoder, a video decoding apparatus, or an image decoding apparatus.

Referring to FIG. 2, the decoding apparatus 200 may include an entropy decoding unit 210, a dequantization unit 220, an inverse transform unit 230, an intra prediction unit 240, a motion compensation unit 250, an adder 201, a switch 203, a filter unit 260, and a reference picture buffer 270.

The decoding apparatus 200 may receive a bitstream output from the encoding apparatus 100. The decoding apparatus 200 may receive a bitstream stored in a computer-readable recording medium, or may receive a bitstream that is streamed through a wired/wireless transmission medium. The decoding apparatus 200 may decode the bitstream in an intra mode or an inter mode. In addition, the decoding apparatus 200 may generate a reconstructed image generated through decoding or a decoded image, and output the reconstructed image or decoded image.

When a prediction mode used for decoding is an intra mode, the switch 203 may be switched to intra. Alternatively, when a prediction mode used for decoding is an inter mode, the switch 203 may be switched to inter.

The decoding apparatus 200 may obtain a reconstructed residual block by decoding the input bitstream, and generate a prediction block. When the reconstructed residual block and the prediction block are obtained, the decoding apparatus 200 may generate a reconstructed block that becomes a decoding target by adding the reconstructed residual block and the prediction block. The decoding target block may be called a current block.

The entropy decoding unit 210 may generate symbols by entropy decoding the bitstream according to a probability distribution. The generated symbols may include a symbol of a quantized level form. Herein, an entropy decoding method may be an inverse process of the entropy encoding method described above.

The entropy decoding unit 210 may change a one-dimensional vector-shaped coefficient into a two-dimensional block-shaped coefficient through a transform coefficient scanning method to decode a transform coefficient level (quantized level).

A quantized level may be dequantized in the dequantization unit 220, or inversely transformed in the inverse transform unit 230. The quantized level may be a result of dequantization and/or inverse transform, and may be generated as a reconstructed residual block. Herein, the dequantization unit 220 may apply a quantization matrix to the quantized level. The dequantization unit 220 and the inverse transform unit 230 applied to the decoding apparatus may apply the same technology as the dequantization unit 160 and inverse transform unit 170 applied to the aforementioned encoding apparatus.

When an intra mode is used, the intra prediction unit 240 may generate a prediction block by performing, on the current block, spatial prediction that uses a sample value of a block which has been already decoded around a decoding target block. The intra prediction unit 240 applied to the decoding apparatus may apply the same technology as the intra prediction unit 120 applied to the aforementioned encoding apparatus.

When an inter mode is used, the motion compensation unit 250 may generate a prediction block by performing, on the current block, motion compensation that uses a motion vector and a reference image stored in the reference picture buffer 270. The motion compensation unit 250 may generate a prediction block by applying an interpolation filter to a partial region within a reference image when the value of the motion vector is not an integer value. In order to perform motion compensation, it may be determined whether the motion compensation method of the prediction unit included in the corresponding coding unit is a skip mode, a merge mode, an AMVP mode, or a current picture reference mode based on the coding unit, and motion compensation may be performed according to each mode. The motion compensation unit 250 applied to the decoding apparatus may apply the same technology as the motion compensation unit 122 applied to the encoding apparatus described above.

The adder 201 may generate a reconstructed block by adding the reconstructed residual block and the prediction block. The filter unit 260 may apply at least one of inverse-LMCS, a deblocking filter, a sample adaptive offset, and an adaptive loop filter to the reconstructed block or reconstructed image. The filter unit 260 applied to the decoding apparatus may apply the same filtering technology as that applied to the filter unit 180 applied to the aforementioned encoding apparatus.

The filter unit 260 may output the reconstructed image. The reconstructed block or reconstructed image may be stored in the reference picture buffer 270 and used for inter prediction. A reconstructed block that has passed through the filter unit 260 may be a part of a reference image. That is, a reference image may be a reconstructed image composed of reconstructed blocks that have passed through the filter unit 260. The stored reference image may be used later in inter prediction or motion compensation.

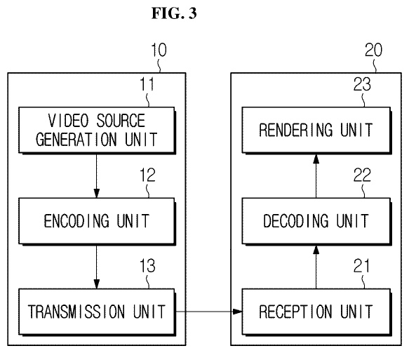

FIG. 3 is a diagram schematically showing a video coding system to which the present invention is applicable.

A video coding system according to an embodiment may include an encoding apparatus 10 and a decoding apparatus 20. The encoding apparatus 10 may transmit encoded video and/or image information or data to the decoding apparatus 20 in the form of a file or streaming through a digital storage medium or a network.

The encoding apparatus 10 according to an embodiment may include a video source generation unit 11, an encoding unit 12, and a transmission unit 13. The decoding apparatus 20 according to an embodiment may include a reception unit 21, a decoding unit 22, and a rendering unit 23. The encoding unit 12 may be called a video/image encoding unit, and the decoding unit 22 may be called a video/image decoding unit. The transmission unit 13 may be included in the encoding unit 12. The reception unit 21 may be included in the decoding unit 22. The rendering unit 23 may include a display unit, and the display unit may be configured as a separate device or an external component.

The video source generation unit 11 may obtain the video/image through a process of capturing, synthesizing, or generating the video/image. The video source generation unit 11 may include a video/image capture device and/or a video/image generation device. The video/image capture device may include, for example, one or more cameras, a video/image archive including previously captured video/image, etc. The video/image generation device may include, for example, a computer, a tablet, and a smartphone, etc., and may (electronically) generate the video/image. For example, a virtual video/image may be generated through a computer, etc., in which case the video/image capture process may be replaced with a process of generating related data. The encoding unit 12 may encode the input video/image.

The encoding unit 12 may perform a series of procedures such as prediction, transform, and quantization for compression and encoding efficiency. The encoding unit 12 may output encoded data (encoded video/image information) in the form of a bitstream. The detailed configuration of the encoding unit 12 may also be configured in the same manner as the encoding apparatus 100 of FIG. 1 described above.

The transmission unit 13 may transmit encoded video/image information or data output in the form of a bitstream to the reception unit 21 of the decoding apparatus 20 through a digital storage medium or a network in the form of a file or streaming. The digital storage medium may include various storage media such as USB, SD, CD, DVD, Blu-ray, HDD, SSD, etc. The transmission unit 13 may include an element for generating a media file through a predetermined file format and may include an element for transmission through a broadcasting/communication network. The reception unit 21 may extract/receive the bitstream from the storage medium or the network and transmit it to the decoding unit 22.

The decoding unit 22 may decode the video/image by performing a series of procedures such as dequantization, inverse transform, and prediction corresponding to the operation of the encoding unit 12. The detailed configuration of the decoding unit 22 may also be configured in the same manner as the above-described decoding apparatus 200 of FIG. 2.

The rendering unit 23 may render the decoded video/image. The rendered video/image may be displayed through the display unit.

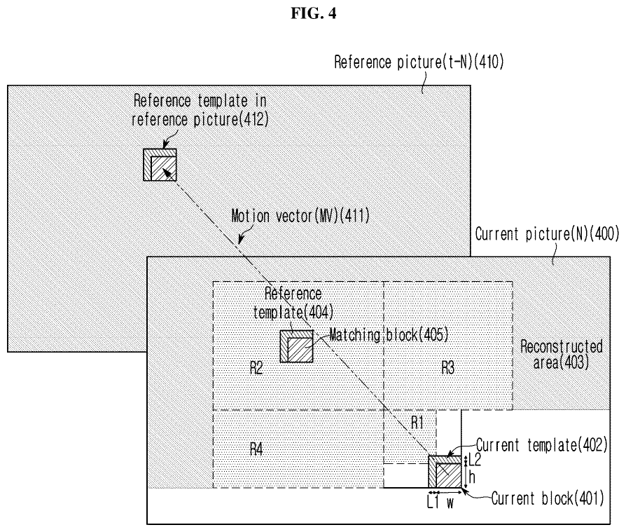

Hereinafter a combined intra inter prediction (CIIP) method according to an embodiment of the present invention will be described with reference to FIG. 4 to FIG. 7.

In the present specification, combined intra inter prediction may mean prediction that is performed through weighted summation of an intra prediction signal and an inter prediction signal. Herein, the intra prediction signal may mean an intra prediction sample or an intra prediction block, and the inter prediction signal may mean an inter prediction sample or an inter prediction block.

In addition, the weighted summation of combined intra inter prediction may be performed as in Formula 1 below.

$${P}_{CIIP} = {w}_{inter} \times {P}_{inter} + {w}_{intra} \times {P}_{intra} \qquad [ Formula 1 ]$$

In Formula 1, P_{CIIP} represents a combined intra inter prediction signal, Pᵢₙₜₑᵣ represents an inter prediction signal that is predicted by inter prediction, and Pᵢₙₜᵣₐ represents an intra prediction signal that predicted by intra prediction. In addition, wᵢₙₜₑᵣ and wᵢₙₜᵣₐ are a weight of the inter prediction signal and a weight of the intra prediction signal, respectively, and wᵢₙₜₑᵣ+wᵢₙₜᵣₐ=1, wᵢₙₜₑᵣ≥0 and wᵢₙₜᵣₐ≥0.

In addition, in the present specification, a reference sample may mean a reference pixel.

In addition, in the present specification, the terms “combined intra inter prediction” and “combined inter intra prediction” may have the same meaning.

FIG. 4 is a view for describing a combined inter intra prediction method based on intra template matching according to an embodiment of the present invention.

An intra template matching-based combined intra inter prediction method may generate an intra prediction block by using an intra template matching method and generate an inter prediction block by using an inter prediction method of a merge mode. In addition, a final prediction block may be generated by performing weighted summation of the intra prediction block and the inter prediction block.

Herein, the intra template matching prediction (IntraTMP) method means a method for searching for an optimal prediction block in a reconstructed area of a current picture by using template matching and for generating a prediction block of a current block by copying the optimal prediction block.

Referring to FIG. 4, a neighboring-area of a current block 401 (that is, a left, upper and upper-left area) may be defined as a current template 402. In addition, a most similar reference template 404 to the current template 402 may be searched within predefined search ranges R1, R2, R3 and R4 of a reconstructed area 403 of a current picture 400. In addition, an intra prediction block of the current block 401 may be derived based on a matching block 405 corresponding to the determined reference template 404.

The predefined search ranges R1, R2, R3 and R4 in FIG. 4 may be defined as a current coding tree unit (CTU) including the current block, an upper-left CTU, an upper CTU, and a left CTU, respectively.

In addition, the predefined search ranges may be searched for a reference template based on a predefined search order. As an example, a reference template may be searched in a zigzag order of R1, R4, R3, and R2.

Meanwhile, information on a search range and the size and shape of a current template may be determined in an encoder and transmitted to a decoder. In addition, a search range and the size and shape of a current template may be set to predetermined values in an encoder/decoder.

As an example, instead of a r-shaped template using both a left reconstructed area and an upper reconstructed area, either the upper reconstructed area or the left reconstructed area alone may be used as a template.

As an example, the size of a current template may be determined by (w×L2)+ (L1×h)+ (L1×L2) as in FIG. 4. Here, w and h may represent the width and height of the current block, and the values of L1 and L2 may be determined as arbitrary positive integers.

As for template shapes, the example of FIG. 4 searches for a most similar reference template to a current template by using one r-shaped template, but this is merely one example, and it is possible to search for a most similar reference template to a current template by using an L-shared template, a template using only an upper area, a template using only a left area, or a template having an arbitrary shape.

In addition, an inter prediction method of a merge mode may generate an inter prediction block from motion information of a specific merge index within a merge candidate list. Herein, a specific merge candidate within the merge candidate list for inter prediction may be determined by using template matching.

Alternatively, the specific merge candidate may be determined by transmitting/parsing merge candidate index information.

In FIG. 4, the current picture 400 is a picture at time t, and the reference picture 410 is a picture at time t−N. Herein t and N are arbitrary positive integers, 0≤t−N<t. In FIG. 4, the reference picture is illustrated as a picture that is temporally prior to the current picture; however, this is merely an example, and the reference picture may be a picture that is temporally subsequent to the current picture.

In addition, although FIG. 4 illustrates a unidirectional motion vector as an example, the motion vector may be a bidirectional motion vector.

In the present embodiment, whether the intra template matching-based combined intra inter combined method is applied may be determined based on the size of the current block.

For example, the intra template matching-based combined intra inter prediction method may be applied only when a horizontal length and/or a vertical length of a current block is equal to or greater than an arbitrary value (e.g., 4) or/and is equal to or less than an arbitrary value (e.g., 64).

As another example, the intra template matching-based combined intra inter prediction method may be applied only when the product of horizontal length and vertical length of a current block is equal to or less than an arbitrary value (e.g., 1024).

In the present embodiment, the intra template matching-based combined intra inter prediction method may be applied according to the size of a current CTU.

For example, the intra template matching-based combined intra inter prediction method may be applied only when the width/height of a current CTU is an arbitrary value (e.g., 128, 256, etc.).

In the intra template matching-based combined intra inter prediction method, an inter prediction weight Wᵢₙₜₑᵣ and an intra prediction weight Wᵢₙₜᵣₐ may be determined based on a distortion value of an intra prediction block and a distortion value of an inter prediction block.

Referring to FIG. 4, a distortion Dᵢₙₜᵣₐ of an intra prediction block may be determined by calculating a difference between the current template 402, which uses a neighboring reference sample of the current block 401, and the reference template 404 that is searched for within the predefined search ranges R1, R2, R3 and R4 of the reconstructed area 403 and is most similar to the current template 402.

A distortion Dᵢₙₜₑᵣ of an inter prediction block may be determined by calculating a difference between the current template 402, which uses a neighboring reference sample of the current block, and a reference template 412 of a corresponding block within the reference picture 410 generated from motion information of a specific merge index within a merge candidate list.

Specifically, a template matching-based combined intra inter prediction method, a weight Wᵢₙₜₑᵣ of an inter prediction signal and a weight Wᵢₙₜᵣₐ of an intra prediction signal may be calculated by using Formula 2.

$${w}_{inter} = \frac{{D}_{intra}}{{D}_{intra} + {D}_{inter}} \qquad [ Formula 2 ]$$

$${w}_{intra} = \frac{{D}_{inter}}{{D}_{intra} + {D}_{inter}}$$

Considering that the smaller the distortion value the greater the similarity between a prediction signal and an original signal, while the greater the distortion value the smaller the similarity between the prediction signal and the original signal, Formula 2 calculates a weight of each signal by using distortion of different signals.

The distortion of each signal may be calculated by using various correlation measurement methods such as the sum of absolute differences (SAD) or the sum of square error (SSE).

FIG. 4 uses a r-shaped template using both a left reference sample and an upper reference sample to calculate a distortion of a signal, but this is merely one example, and it is possible to use a template that uses only the left reference sample or the upper reference sample.

Arbitrary weights, which are preset in an encoder and a decoder, may be used for a weight of an inter prediction signal and a weight of an intra prediction signal.

Another method for determining weights may determine a weight of an inter prediction signal and a weight of an intra prediction signal by signaling an arbitrary index among indexes of predefined N weights. Herein, N is an arbitrary positive integer. In addition, the sum of a weight of an inter prediction signal and a weight of an intra prediction signal may be 1.

Still another method for determining weights may use information on a neighboring reference block of a current block. Specifically, a weight Wᵢₙₜₑᵣ of an inter prediction signal and a weight Wᵢₙₜᵣₐ of an intra prediction signal may be determined based on types of a prediction mode of an upper neighboring block of a current block and a prediction mode of a left neighboring block of the current block.

TABLE 1

Prediction mode types

| | | |
|---|---|---|
| Upper neighbor | Left neighbor | Weights |

| block | block | W_{Inter} | W_{Intra} |
|---|---|---|---|
| Inter prediction | Inter prediction | ¾ | ¼ |
| Inter prediction | Intra prediction | 2/4 | 2/4 |
| Intra prediction | Inter prediction | 2/4 | 2/4 |
| Intra prediction | Intra prediction | ¼ | ¾ |

Referring to Table 1, when the prediction mode types of an upper neighboring block and a left neighboring block are an inter prediction mode, a greater weight may be assigned to a prediction value generated from the inter prediction mode. On the other hand, when the prediction mode types of the upper neighboring block and the left neighboring block are an intra prediction mode, a greater weight may be assigned to a prediction value that is derived based on intra prediction. When both the upper neighboring block and the left neighboring block have an inter prediction mode and an intra prediction mode respectively, a same weight may be assigned to a prediction value generated from the inter prediction mode and a prediction value generated from the intra prediction mode.

Meanwhile, a weight set in Table 1 is merely one example, and an arbitrary weight may be assigned.

In addition, two neighboring blocks are referenced to determine a weight in Table 1, but this is merely one example, and M neighboring blocks of a current block may be referenced. Herein, M is an arbitrary positive integer. As an example, a weight Wᵢₙₜₑᵣ of a prediction value generated from an inter prediction mode and a weight Wᵢₙₜᵣₐ of a prediction value derived from an intra prediction mode may be calculated as in Formula 3.

$${W}_{Inter} = \frac{{N}_{Inter}}{M} , {W}_{Intra} = \frac{{N}_{Intra}}{M} \qquad [ Formula 3 ]$$

In Formula 3, Nᵢₙₜₑᵣ and Nᵢₙₜᵣₐ mean the number of reference blocks encoded in an inter prediction mode and the number of reference blocks encoded in an intra prediction mode, respectively, among M neighboring reference blocks adjacent to a current block.

Meanwhile, in Table 1, an intra prediction mode may represent only an intra template matching prediction mode.

Herein, when a prediction mode of a neighboring reference block is neither an inter prediction mode not an intra template matching prediction mode, the reference block may be excluded in determining a weight.

In addition, when a prediction mode of a neighboring reference block is an intra prediction mode that is not an intra template matching prediction mode, the prediction mode may be considered the intra template matching mode and be used to determine a weight.

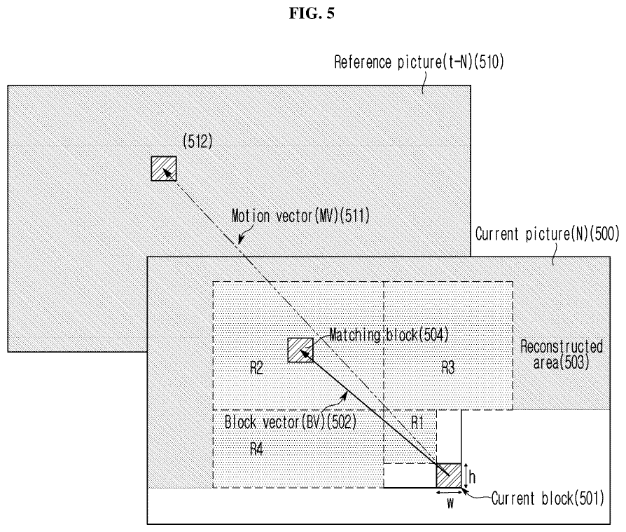

FIG. 5 is a view for describing a combined inter intra prediction method based on intra block copy according to an embodiment of the present invention.

An intra block copy-based combined intra inter prediction method may generate an intra prediction block by using an intra block copy method and generate an inter prediction block by using an inter prediction method of a merge mode. In addition, a final prediction block may be generated by performing weighted summation of the intra prediction block and the inter prediction block.

Herein, the intra block copy (IBC) method means a method for searching for an optimal prediction block in a reconstructed area of a current picture by using a block vector and for generating a prediction block of a current block by copying the optimal prediction block.

Referring to FIG. 5, based on a block vector 502 of a current block 501, a matching block 504 may be derived within predefined search ranges R1, R2, R3 and R4 of a reconstructed area of a current picture 500. In addition, an intra prediction block of the current block 501 may be derived based on the matching block 504.

The predefined search ranges R1, R2, R3 and R4 in FIG. 5 may be defined as a current coding tree unit (CTU) including the current block, an upper-left CTU, an upper CTU, and a left CTU, respectively.

Meanwhile, in FIG. 5, a matching block is described to be derived within a predefined search range, but a matching block may also be derived based on a block vector in a reconstructed area within a current picture.

In the intra block copy-based combined intra inter prediction method described in FIG. 5, as intra block copy generates a prediction block based on a block vector, that is, motion information, syntax information related to the motion information is to be transmitted to a decoder. Herein, as a larger amount of motion information to be encoded reduces coding efficiency, the present specification proposes a method of efficiently encoding motion information (that is, a block vector) as follows.

As illustrated in FIG. 5, when the current block 501 is in the intra block copy-based combined intra inter prediction mode, inter prediction may generate an inter prediction block by using a motion vector (MV), and intra prediction may generate an intra prediction block by using a block vector (BV). A motion vector (MV) used in inter prediction may be used to reduce an amount of information on a block vector used in intra prediction.

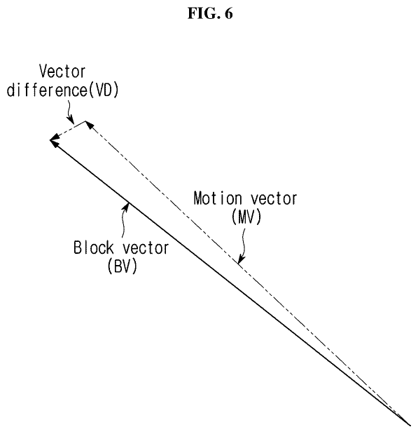

FIG. 6 is a view showing a method for reducing an amount of information on a block vector by using a motion vector according to an embodiment of the present invention.

Referring to FIG. 6, the dotted line represents a motion vector 511 for inter prediction, and the solid line represents the block vector 502 for intra prediction. When a motion vector and a block vector are compared, the two vectors may be actually similar. Considering this feature, it is possible to efficiently reduce an amount of information on a block vector to be transmitted to a decoder by encoding a vector difference (VD) between a motion vector and the block vector, instead of encoding the block vector itself.

Formula 4 expresses a difference of vector (DV) between a motion vector and a block vector.

$$D {V}_{x} = M {V}_{x} - B {V}_{x} \qquad [ Formula 4 ]$$

$$D {V}_{y} = M {V}_{y} - B {V}_{y}$$

In Formula 4, MVx, BVx, and DVx represent a motion vector in direction x, a block vector in direction x, and a difference between the motion vector in direction x and the block vector in direction x, respectively. In addition, in Formula 4, MVy, BVy, and DVy represent a motion vector in direction y, a block vector in direction y, and a difference between the motion vector in direction y and the block vector in direction y, respectively.

Herein, a motion vector resolution and a block vector resolution may be different from each other. In this case, the motion vector resolution may be adjusted to the block vector resolution, and conversely the block vector resolution may be adjusted to the motion vector resolution.

In addition, at least one of a motion vector and a block vector may be scaled based on a distance between the current picture 500 and the reference picture 510 (as an example, a difference in picture of count).

Meanwhile, contrary to what is described in FIG. 6, a block vector may be derived first, and then a motion vector for generating an inter prediction block may be derived by using the derived block vector. In this case, a difference from the motion vector may be calculated in the block vector. It is possible to efficiently reduce an amount of information on the block vector to be transmitted to a decoder by encoding a vector difference (VD) between the block vector and the motion vector, instead of encoding the motion vector itself.

Meanwhile, an inter prediction method of a merge mode may generate an inter prediction block from motion information of a specific merge index within a merge candidate list. Herein, a specific merge candidate within the merge candidate list for inter prediction may be determined by using template matching.

Alternatively, the specific merge candidate may be determined by transmitting/parsing merge candidate index information.

In FIG. 5, the current picture 500 is a picture at time t, and the reference picture 510 is a picture at time t−N. Herein t and N are arbitrary positive integers, 0≤t−N<t. In FIG. 5, the reference picture is s illustrated as a picture that is temporally prior to the current picture; however, this is merely an example, and the reference picture may be a picture that is temporally subsequent to the current picture.

In addition, although FIG. 5 illustrates a unidirectional motion vector as an example, the motion vector may be a bidirectional motion vector.

In the present embodiment, whether the intra block copy-based combined intra inter combined method is applied may be determined based on a size of a current block.

For example, the intra block copy-based combined intra inter prediction method may be applied only when a horizontal length and/or a vertical length of a current block is equal to or greater than an arbitrary value (e.g., 4) or/and is equal to or less than an arbitrary value (e.g., 64).

As another example, the intra block copy-based combined intra inter prediction method may be applied only when the product of horizontal length and vertical length of a current block is equal to or less than an arbitrary value (e.g., 1024).

In the present embodiment, the intra block copy-based combined intra inter prediction method may be applied according to the size of a current CTU.

For example, the intra block copy-based combined intra inter prediction method may be applied only when the width/height of a current CTU is an arbitrary value (e.g., 128, 256, etc.).

In the intra block copy-based combined intra inter prediction method, an inter prediction weight Wᵢₙₜₑᵣ and an intra prediction weight Wᵢₙₜᵣₐ may be determined based on a distortion value of an intra prediction block and a distortion value of an inter prediction block.

Referring to FIG. 5, a distortion Dᵢₙₜᵣₐ of an intra prediction block may be determined by calculating a difference between the current block 501 and the most similar matching block 504 found within the predefined search ranges R1, R2, R3 and R4 of the reconstructed area 503.

A distortion Dᵢₙₜₑᵣ of an inter prediction block may be determined by calculating a difference between the current block 501 and the corresponding block 512 within the reference picture 510 generated from motion information of a specific merge index within a merge candidate list.

Specifically, in the intra block copy-based combined intra inter prediction method, a weight Wᵢₙₜₑᵣ of an inter prediction signal and a weight Wᵢₙₜᵣₐ of an intra prediction signal may be calculated by using Formula 2 above.

Meanwhile, as the distortion value is derived using information on the current block 510 (as an example, a sample value of the current block), the distortion value may be signaled through a bitstream.

Meanwhile, the distortion of each signal may be calculated by using various correlation measurement methods such as the sum of absolute differences (SAD) or the sum of square error (SSE).

Arbitrary weights, which are preset in an encoder and a decoder, may be used for a weight of an inter prediction signal and a weight of an intra prediction signal.

Another method for determining weights may determine a weight of an inter prediction signal and a weight of an intra prediction signal by signaling an arbitrary index among indexes of predefined N weights. Herein, N is an arbitrary positive integer. In addition, the sum of a weight of an inter prediction signal and a weight of an intra prediction signal may be 1.

Still another method for determining weights may use information on a neighboring reference block of a current block. Specifically, a weight Wᵢₙₜₑᵣ of an inter prediction signal and a weight Wᵢₙₜᵣₐ of an intra prediction signal may be determined based on types of a prediction mode of an upper neighboring block of a current block and a prediction mode of a left neighboring block of the current block.

As in Table 1, when the prediction mode types of an upper neighboring block and a left neighboring block are an inter prediction mode, a greater weight may be assigned to a prediction value generated from the inter prediction mode. On the other hand, when the prediction mode types of the upper neighboring block and the left neighboring block are an intra prediction mode, a greater weight may be assigned to a prediction value that is derived based on intra prediction. When both the upper neighboring block and the left neighboring block have an inter prediction mode and an intra prediction mode respectively, a same weight may be assigned to a prediction value generated from the inter prediction mode and a prediction value generated from the intra prediction mode.

Meanwhile, two neighboring blocks are referenced to determine a weight, but this is merely one example, and M neighboring blocks of a current block may be referenced. Herein, M is an arbitrary positive integer. As an example, a weight Wᵢₙₜₑᵣ of a prediction value generated from an inter prediction mode and a weight Wᵢₙₜᵣₐ of a prediction value derived from an intra prediction mode may be calculated as in Formula 3 above.

Meanwhile, in Table 1 above, an intra prediction mode may represent only an intra block copy mode.

Herein, when a prediction mode of a neighboring reference block is neither an inter prediction mode not an intra block copy mode, the reference block may be excluded in determining a weight.

In addition, when a prediction mode of a neighboring reference block is an intra prediction mode that is not an intra block copy mode, the prediction mode may be considered the intra block copy mode and be used to determine a weight.

Meanwhile, a determined weight may be used after being simplified through an integerization or decimalization method.

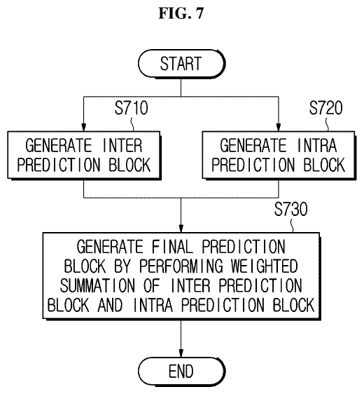

FIG. 7 is a flowchart showing a method for decoding an image according to an embodiment of the present invention.

The image decoding method of FIG. 7 may be performed by an image decoding apparatus.

The image decoding apparatus may generate an inter prediction block of a current block (S710). Specifically, the inter prediction block may be generated by performing inter prediction of a merge mode.

In addition, the image decoding apparatus may generate an intra prediction block of the current block (S720). Specifically, the intra prediction block may be generated based on one of intra template matching prediction and intra block copy.

Meanwhile, when the intra prediction block is generated based on intra block copy, a block vector used for the intra block copy may be determined based on a motion vector that is used to generate the inter prediction block. Specifically, the block vector may be derived by adding a vector difference value to the motion vector, and the vector difference value may be obtained from a bitstream. An embodiment about this is described in detail in FIG. 6.

Meanwhile, a resolution of the block vector may be adjusted based on a resolution of the motion vector. Conversely, the resolution of the motion vector may be adjusted based on the resolution of the block vector.

Meanwhile, the block vector may be derived based on a distance between a current picture including the current block and a reference picture that is used to generate the inter prediction block.

In addition, the image decoding apparatus may generate a final prediction block by performing weighted summation of the inter prediction block and the intra prediction block. Specifically, the weighted summation may be performed by applying an inter prediction weight and an intra prediction weight to the inter prediction block and the intra prediction block, respectively.

Herein, the inter prediction weight and the intra prediction weight may be determined based on a distortion value of the inter prediction block and a distortion value of the intra prediction block.

In addition, the inter prediction weight and the intra prediction weight may be determined based on a prediction mode of at least two neighboring blocks of the current block.

Meanwhile, the steps described in FIG. 7 may be performed likewise in an image encoding method. In addition, a bitstream may be generated by an image encoding method including the steps described in FIG. 7. The bitstream may be stored in a non-transitory computer-readable recording medium and also be transmitted (or streamed).

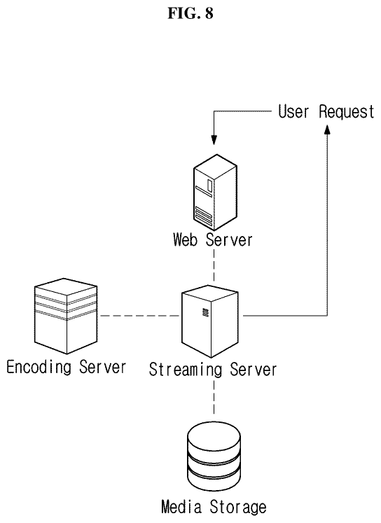

FIG. 8 exemplary illustrates a content streaming system to which an embodiment according to the present invention is applicable.

As illustrated in FIG. 8, a content streaming system to which an embodiment of the present invention is applied may largely include an encoding server, a streaming server, a web server, a media storage, a user device, and a multimedia input device.

The encoding server compresses content received from multimedia input devices such as smartphones, cameras, CCTVs, etc. into digital data to generate a bitstream and transmits it to the streaming server. As another example, if multimedia input devices such as smartphones, cameras, CCTVs, etc. directly generate a bitstream, the encoding server may be omitted.

The bitstream may be generated by an image encoding method and/or an image encoding apparatus to which an embodiment of the present invention is applied, and the streaming server may temporarily store the bitstream in the process of transmitting or receiving the bitstream.

The streaming server transmits multimedia data to a user device based on a user request via a web server, and the web server may act as an intermediary that informs the user of any available services. When a user requests a desired service from the web server, the web server transmits it to the streaming server, and the streaming server may transmit multimedia data to the user. At this time, the content streaming system may include a separate control server, and in this case, the control server may control commands/responses between devices within the content streaming system.

The streaming server may receive content from media storage and/or an encoding server. For example, when receiving content from the encoding server, the content may be received in real time. In this case, in order to provide a smooth streaming service, the streaming server may store the bitstream for a certain period of time.

Examples of the user devices may include mobile phones, smartphones, laptop computers, digital broadcasting terminals, personal digital assistants (PDAs), portable multimedia players (PMPs), navigation devices, slate PCs, tablet PCs, ultrabooks, wearable devices (e.g., smartwatches, smart glasses, HMDs), digital TVs, desktop computers, digital signage, etc.

Each server in the above content streaming system may be operated as a distributed server, in which case data received from each server may be distributed and processed.

The above embodiments may be performed in the same or corresponding manner in the encoding apparatus and the decoding apparatus. In addition, an image may be encoded/decoded using at least one or a combination of at least one of the above embodiments.

The order in which the above embodiments are applied may be different in the encoding apparatus and the decoding apparatus. Alternatively, the order in which the above embodiments are applied may be the same in the encoding apparatus and the decoding apparatus.

The above embodiments may be performed for each of the luma and chroma signals. Alternatively, the above embodiments for the luma and chroma signals may be performed identically.

In the above-described embodiments, the methods are described based on the flowcharts with a series of steps or units, but the present invention is not limited to the order of the steps, and rather, some steps may be performed simultaneously or in different order with other steps. In addition, it should b appreciated by one of ordinary skill in the art that the steps in the flowcharts do not exclude each other and that other steps may be added to the flowcharts or some of the steps may be deleted from the flowcharts without influencing the scope of the present invention.

The embodiments may be implemented in a form of program instructions, which are executable by various computer components, and recorded in a computer-readable recording medium. The computer-readable recording medium may include stand-alone or a combination of program instructions, data files, data structures, etc. The program instructions recorded in the computer-readable recording medium may be specially designed and constructed for the present invention, or well-known to a person of ordinary skill in the computer software technology field.

A bitstream generated by the encoding method according to the above embodiment may be stored in a non-transitory computer-readable recording medium. In addition, a bitstream stored in the non-transitory computer-readable recording medium may be decoded by the decoding method according to the above embodiment.

Examples of the computer-readable recording medium include magnetic recording media such as hard disks, floppy disks, and magnetic tapes; optical data storage media such as CD-ROMs or DVD-ROMs; magneto-optimum media such as floptical disks; and hardware devices, such as read-only memory (ROM), random-access memory (RAM), flash memory, etc., which are particularly structured to store and implement the program instruction. Examples of the program instructions include not only a mechanical language code formatted by a compiler but also a high-level language code that may be implemented by a computer using an interpreter. The hardware devices may be configured to be operated by one or more software modules or vice versa to conduct the processes according to the present invention.

Although the present invention has been described in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

### INDUSTRIAL APPLICABILITY

The present invention may be used in an apparatus for encoding/decoding an image and a recording medium for storing a bitstream.

What is claimed is:

1. A method for decoding an image, the method comprising:
generating an inter prediction block of a current block;
generating an intra prediction block of the current block; and
generating a final prediction block of the current block by performing weighted summation of the inter prediction block and the intra prediction block,
wherein the intra prediction block is generated based on one of intra template matching prediction and intra block copy.

2. The method of claim 1, wherein an inter prediction mode is generated by performing inter prediction of a merge mode.

3. The method of claim 1, wherein, when the intra prediction block is generated based on intra block copy, a block vector used for the intra block copy is determined based on a motion vector that is used to generate the inter prediction block.

4. The method of claim 3, wherein the block vector is derived by adding a vector difference value to the motion vector.

5. The method of claim 4, wherein the vector difference value is obtained from a bitstream.

6. The method of claim 3, wherein the block vector is derived based on a distance between a current picture including the current block and a reference picture that is used to generate the inter prediction block.

7. The method of claim 3, wherein a resolution of the block vector is adjusted based on a resolution of the motion vector.

8. The method of claim 3, wherein a resolution of the motion vector is adjusted based on a resolution of the block vector.

9. The method of claim 1, wherein the weighted summation is performed by applying an inter prediction weight and an intra prediction weight to the inter prediction block and the intra prediction block, respectively.

10. The method of claim 9, wherein the inter prediction weight and the intra prediction weight are determined based on a distortion value of the inter prediction block and a distortion value of the intra prediction block.

11. The method of claim 9, wherein the inter prediction weight and the intra prediction weight are determined based on a prediction mode of at least two neighboring blocks of the current block.

12. A method for encoding an image, the method comprising:
generating an inter prediction block of a current block;
generating an intra prediction block of the current block; and
generating a final prediction block of the current block by performing weighted summation of the inter prediction block and the intra prediction block,
wherein the intra prediction block is generated based on one of intra template matching prediction and intra block copy.

13. (canceled)

14. A method for transmitting a bitstream, the bitstream being generated by a method for encoding an image,
wherein the method for transmitting a bitstream comprises transmitting the bitstream,
wherein the method for encoding an image comprises:
generating an inter prediction block of a current block;
generating an intra prediction block of the current block; and
generating a final prediction block of the current block by performing weighted summation of the inter prediction block and the intra prediction block, and
wherein the intra prediction block is generated based on one of intra template matching prediction and intra block copy.
